(19) United States
(12) Patent Application Publication
(10) Pub. No.: US 2011/0227788 A1
(43) Pub. Date: Sep. 22, 2011

(54) METHOD AND SYSTEM FOR GENERATING AND PROPAGATING LOCATION INFORMATION BY A MOBILE DEVICE USING SENSORY DATA

(76) Inventors: David Lundgren, Mill Valley, CA (US); Charles Abraham, Los Gatos, CA (US); Mark Buer, Gilbert, AZ (US); David Garrett, Tustin, CA (US); Jeyhan Karaoguz, Irvine, CA (US); David Murray, Mission Viejo, CA (US)

(21) Appl. No.: 12/748,016

(22) Filed: Mar. 26, 2010

Related U.S. Application Data
(60) Provisional application No. 61/314,521, filed on Mar. 16, 2010.

(51) Int. Cl. G01S 19/45; G01S 19/51

(52) U.S. Cl. 342/357.28; 342/357.34

(57) ABSTRACT

A mobile device may determine its initial absolute location; may track using a plurality of sensors, its movements relative to the initial absolute location; and may generate location related data for a location based on that tracking. Tracking movement of the mobile device may comprise generating data corresponding to three-dimensional (3D) linear and/or rotational changes in position and/or location of the mobile device. The initial absolute location may be determined directly by the mobile device, based on GNSS signals and/or assisted GNSS (A-GNSS) data received from one or more location servers; and/or it may be estimated based on a location of a communication device that is communicatively coupled to the mobile device. The generated location related data may propagated by the mobile device to other mobile and/or communication devices, and/or to the location servers, where a reference database for supporting location related services (LBS) may be updated accordingly.

### CROSS-REFERENCE TO RELATED APPLICATIONS/INCORPORATION BY REFERENCE

This patent application makes reference to, claims priority to and claims benefit from U.S. Provisional Application Ser. No. 61/314,521 (Attorney Docket Number 21018US01) filed on Mar. 16, 2010. This application makes reference to:
U.S. Provisional Application Ser. No. 61/304,085 (Attorney Docket Number 20999US01) which was filed on Feb. 12, 2010;
U.S. application Ser. No. ______ (Attorney Docket Number 20999US02) filed on even date herewith;
U.S. Provisional Application Ser. No. 61/304,114 (Attorney Docket Number 21001 US01) which was filed on Feb. 12, 2010;
U.S. application Ser. No. ______ (Attorney Docket Number 21001US02) filed on even date herewith;
U.S. Provisional Application Ser. No. 61/311,879 (Attorney Docket Number 21004US01) which was filed on Mar. 9, 2010;
U.S. application Ser. No. ______ (Attorney Docket Number 21004US02) filed on even date herewith;
U.S. Provisional Application Ser. No. 61/304,193 (Attorney Docket Number 21005US01) which was filed on Feb. 12, 2010;
U.S. application Ser. No. ______ (Attorney Docket Number 21005US02) filed on even date herewith;
U.S. Provisional Application Ser. No. 61/304,205 (Attorney Docket Number 21006US01) which was filed on Feb. 12, 2010;
U.S. application Ser. No. ______ (Attorney Docket Number 21006US02) filed on even date herewith;
U.S. Provisional Application Ser. No. 61/304,198 (Attorney Docket Number 21011 US01) which was filed on Feb. 12, 2010;
U.S. application Ser. No. ______ (Attorney Docket Number 21011US02) filed on even date herewith;
U.S. Provisional Application Ser. No. 61/305,174 (Attorney Docket Number 21016US01) which was filed on Feb. 17, 2010;
U.S. application Ser. No. ______ (Attorney Docket Number 21016US02) filed on even date herewith;
U.S. Provisional Application Ser. No. 61/304,253 (Attorney Docket Number 21023US01) which was filed on Feb. 12, 2010; and
U.S. application Ser. No. ______ (Attorney Docket Number 21023US02) filed on even date herewith;
U.S. Provisional Application Ser. No. 61/306,639 (Attorney Docket Number 21025US01) which was filed on Feb. 22, 2010; and
U.S. application Ser. No. ______ (Attorney Docket Number 21025US02) filed on even date herewith;

Each of the above stated applications is hereby incorporated herein by reference in its entirety.

### FEDERALLY SPONSORED RESEARCH OR DEVELOPMENT

[Not Applicable].

### MICROFICHE/COPYRIGHT REFERENCE

[Not Applicable].

### FIELD OF THE INVENTION

Certain embodiments of the invention relate to communication. More specifically, certain embodiments of the invention relate to a method and system for generating and propagating location information by a mobile device using sensory data.

### BACKGROUND OF THE INVENTION

Location based services (LBS) applications are emerging as a new type of value-added service provided by mobile communication network. LBS applications are mobile services in which the user location information is used to enable and/or support various applications and/or services such as, for example, enhanced 911 (E-911), location-based 411, location-based messaging and/or location-based friend finding services. A location of a communication device may be determined in different ways such as, for example, using network-based technology, using terminal-based technology, and/or hybrid technology, which may be a combination of the former technologies. Many positioning technologies such as, for example, Time of Arrival (TOA), Observed Time Difference of Arrival (OTDOA), Enhanced Observed Time Difference (E-OTD) as well as the Global navigation satellite-based systems (GNSS) such as Global Positioning System (GPS), Global Navigation Satellite System (GLONASS), Galileo, and/or Assisted-GNSS (A-GNSS), may be utilized to estimate the location (latitude and longitude) and/or elevation of the communication device and convert it into a meaningful X, Y, and/or Z coordinates for Location-Based Services provided via wireless communication systems.

Further limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

A system and/or method is provided for generating and propagating location information by a mobile device using sensory data, substantially as shown in and/or described in connection with at least one of the figures, as set forth more completely in the claims.

These and other advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1 is a block diagram illustrating an exemplary communication system that provides location based services to a plurality of communication devices, in accordance with an embodiment of the invention.

FIG. 2 is a block diagram illustrating an exemplary mobile device that is operable to generate and propagate location information using sensory data, in accordance with an embodiment of the invention.

FIG. 3 is a block diagram illustrating an exemplary processing system that is operable to generate and propagate location information based on sensory data, in accordance with an embodiment of the invention.

FIG. 4 is a block diagram illustrating an exemplary location server, in accordance with an embodiment of the invention.

FIG. 5A is a flow chart that illustrates exemplary steps for generating and propagating location information based on sensory data, in accordance with an embodiment of the invention

FIG. 5B is a flow chart that illustrates exemplary steps for receiving and/or utilizing location related data generated and communicated from a mobile device, in accordance with an embodiment of the invention.

### DETAILED DESCRIPTION OF THE INVENTION

Certain embodiments of the invention may be found in a method and system for generating and propagating location information by a mobile device using sensory data. In various embodiments of the invention, a mobile device, which may comprise a plurality of movement sensors and/or a location device, may determine its initial absolute location, via the location device, and may track its movements relative to the initial absolute location using the plurality of sensors when the mobile device is moving and subsequent absolute locations of said mobile device may not be determined. In this regard, absolute location may refer to the geographical location of a device, e.g. on Earth, which may be defined by a plurality of parameters, comprising, for example, longitude, latitude, and/or elevation (above/below sea-level). The mobile device may generate location related data for a location based on the tracking. The plurality of sensors may be internally integrated into or be externally coupled to the mobile device. Exemplary sensors may comprise magnetic bearing sensors, gyroscopes, altimeters, accelerometers, and/or pedometers. During tracking of movement of the mobile device, data corresponding to three-dimensional (3D) linear and/or rotational changes in position and/or location of the mobile device may be generated. The generation of the location related data for the specific location may be based on various factors comprising the movement data generated during tracking of movement of the mobile device. The mobile device may communicate with other communication and/or mobile devices, and/or with one or more location servers that support location based services (LBS). In this regard, the communication may occur directly or indirectly. The communication with the location servers may be utilized to determine whether the location servers require and/or authorize tracking of movements of the mobile device, and/or generating of corresponding location related data. The mobile device may forward the generated location related data to the other mobile and/or communication devices, and/or to the location servers. A reference database maintained by the location servers for supporting location based services (LBS) may be updated based on the generated location related data.

The initial absolute location may be determined directly by the mobile device, based on GNSS signals and/or assisted GNSS (A-GNSS) data received from one or more location servers. The initial absolute location may also be estimated based on location of one or more communication devices that may be communicatively coupled to the mobile device. Exemplary communication devices may comprise personal communication devices, wireless access points, WiMAX base stations, cellular base stations, and/or femtocells. In this regard, the mobile device may utilize one or more wireless connections to communicate with each communication device, and may utilize the wireless connection for obtaining data corresponding to the absolute location of the communication device, for example.

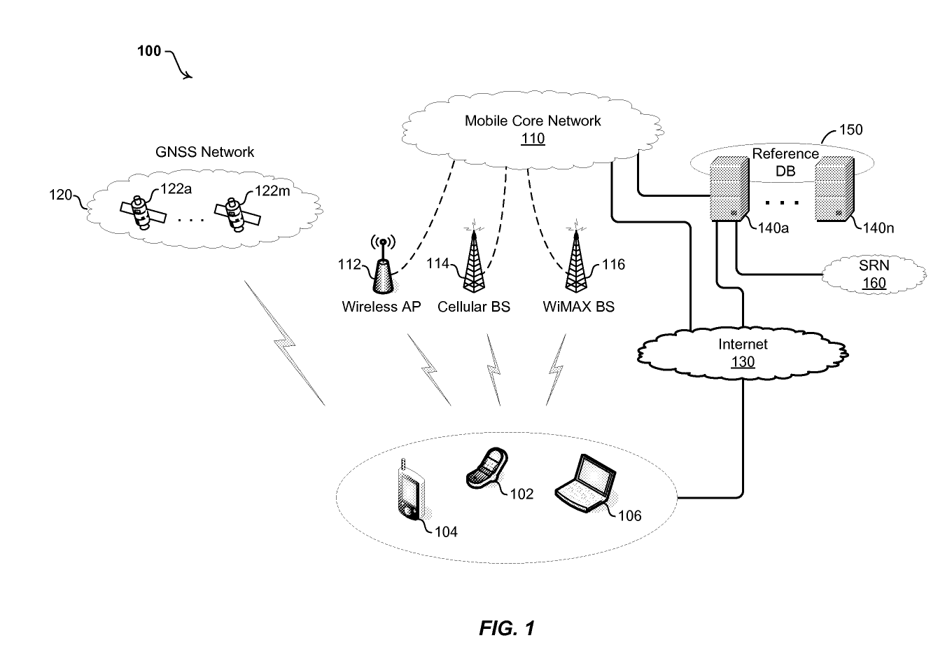

FIG. 1 is a block diagram illustrating an exemplary communication system that provides location based services to a plurality of communication devices, in accordance with an embodiment of the invention. Referring to FIG. 1, there is shown a communication system 100 comprising a plurality of communication devices, of which a wireless access point (AP) 112, a cellular base station (BS) 114, a Worldwide Interoperability for Microwave Access (WiMAX) BS 116, and mobile devices 102-106 are illustrated. Exemplary mobile devices may comprise cellular device 102, Smartphone 104, and/or laptop 106. Also shown in the communication system 100 is a mobile core network 110, a Global Navigation Satellite Systems (GNSS) network 120, a plurality of GNSS satellites 122a-122m, an Internet 130, a plurality of location servers 140a-140n, and a satellite reference network (SRN) 160.

The GNSS network 120 may comprise suitable logic, circuitry, interfaces, and/or code that may provide navigation information to land-based devices via satellite links. The GNSS network 120 may provide positioning information via satellite links broadcasted to land-based devices, such the wireless AP 112, the cellular BS 114, the WiMAX BS 116, and/or the mobile devices 102-106, to enable determining their locations. In this regard, the GNSS network 120 may comprise, for example, the GNSS satellites 122a-122m, each of which is operable to provide satellite transmissions based on a global navigation satellite system (GNSS). Exemplary GNSS systems may comprise, for example, the Global Positioning System (GPS), GLONASS and/or Galileo based satellite system. Land-based devices may utilize a plurality of satellite broadcasts, received from different satellites in the plurality of GNSS satellite 122a-122m for example, to determine their locations, using, for example, triangulation based techniques.

The Internet 130 may comprise a system of interconnected networks and/or devices that enable exchange of information and/or data among a plurality of nodes, based on one or more networking standards, including, for example, Internet Protocols (IP). The Internet 130 may enable, for example, connectivity among a plurality of private and public, academic, business, and/or government nodes and/or networks, wherein the physical connectivity may be provided via the Public Switched Telephone Network (PSTN), utilizing copper wires, fiber-optic cables, wireless interfaces, and/or other standards-based interfaces.

The mobile core network 110 may comprise suitable logic, circuitry, interfaces, and/or code that are operable to provide interfacing and/or connectivity among one or more access networks, which may provide network accessibility to mobile devices. The mobile core network 100 may also provide interacting and/or connectivity with external data networks such as packet data networks (PDNs) and/or the Internet 130. The mobile devices 102-106 may access the mobile core network 110, for example, via the wireless AP 112, the cellular BS 114, and/or the WiMAX BS 116. The mobile core network 110 may be configured to communicate various data services, which are provided by external data networks, to associated users.

The wireless AP 112 may comprise suitable logic, circuitry, interfaces, and/or code that are operable to provide data services to communication devices, such as one or more of the mobile devices 102-106, in adherence with one or more wireless LAN (WLAN) standards, which may comprise, for example, IEEE 802.11, 802.11a, 802.11b, 802.11d, 802.11e, 802.11n, 802.11v, and/or 802.11u. The wireless AP 112 may communicate with the mobile core network 110 and/or the Internet 130, via one or more links and/or associated devices for example. In this manner, the wireless AP 112 may provide network access to the mobile devices 102-106.

The cellular BS 114 may comprise suitable logic, circuitry, interfaces, and/or code that are operable to provide voice and/or data services to communication devices, such as one or more of the mobile devices 102-106, in adherence with one or more cellular communication standards. Exemplary cellular communication standards may comprise Global System for Mobile communications (GSM), General Packet Radio Services (GPRS), Universal Mobile Telecommunications System (UMTS), Enhanced Data rates for GSM Evolution (EDGE), Enhanced GPRS (EGPRS), and/or 3GPP Long Term Evolution (LTE). The cellular BS 114 may communicate with the mobile core network 110 and/or the Internet 130, via one or more backhaul links and/or associated devices for example. In this manner, the cellular BS 114 may provide network access to the mobile devices 102-106.

The WiMAX BS 116 may comprise suitable logic, circuitry, interfaces, and/or code that are operable to provide WiMAX based data services to communication devices, such as one or more of the mobile devices 102-106. The WiMAX BS 116 may communicate with the mobile core network 110 and/or the Internet 130, via one or more backhaul links and/or associated devices for example. In this manner, the WiMAX BS 116 may provide network access to the mobile devices 102-106.

Each of the mobile devices 102-106 may comprise suitable logic, circuitry, interfaces, and/or code for implementing various aspects of the invention disclosed herein. In this regard, each of the mobile devices 102-106 may be operable to communicate via a plurality of wired and/or wireless connections, based on one or more wired and/or wireless protocols and/or standards. For example, each of the mobile devices 102-106 may be operable to transmit and/or receive signals to and/or from one or more of the wireless AP 112, the cellular BS 114, WiMAX BS 116, GNSS network 120, and/or the Internet 130. Also, each of the mobile devices 102-106 may be operable to communicate with, and/or receive services provided by the Internet 130 and/or the mobile core network 110. The mobile devices 102-106 may also be operable to utilize and/or support LBS applications. In an exemplary aspect of the invention, mobile devices, such as one or more of the mobile devices 102-106, may be utilized to generate and/or propagate location related information. In this regard, the location related data may be generated based on, for example, movement of a mobile device at a certain location.

Each of plurality of location servers 140a-140n may comprise suitable logic, circuitry, interfaces, and/or code that are operable to provide and/or support location based services (LBS). In this regard, the location servers 140a-140n may store and/or process location related data associated with communication devices, and may provide location related data when requested to do so. The plurality of location servers 140a-140n also operable to collect and/or update location related data independently and/or autonomously, by communicating with and/or accessing the SRN 160 for example. The SRN 160 may comprise suitable logic, circuitry, interfaces, and/or code that are operable to collect, compile, and/or distribute data GNSS based data, on a continuous basis. The collected data may be utilized to provide location information to devices and/or entities in lieu of and/or in addition to location data that are collected by other means (e.g. directly based on GNSS reception). In this regard, the SRN 160 may comprise a plurality of GNSS reference tracking stations located around the world to provide Assisted-GNSS (A-GNSS) coverage all the time in both a home network and/or any visited network. The SRN 160 may utilize, for example, satellite signals received from various GNSS constellations, such as, for example, the plurality of GNSS satellites 122a-122m of the GNSS network 120. The plurality of location servers 140a-140n may utilize a reference database 150 for maintaining profile elements comprising location related data corresponding to a plurality of communication devices. In this regard, each profile element in the reference database 150 may comprise information that associates location data, such as latitude and longitude (LAT/LON) and/or altitude for example, with unique identifying parameters corresponding to communication devices. Furthermore, in some instances the profile elements may also comprise additional information. For example, for communication devices that may provide network access to other devices, such as wireless access points, WiMAX base stations, cellular base stations, and/or femtocells, corresponding location related profile elements may comprise, in addition to location and/or identifying information, operability related data, such as, for example, scrambling codes, frequencies and/or other broadcast attributes

In an exemplary aspect of the invention, the location servers 140a-140n may be operable to receive and/or use, for LBS applications, location related data from the communication devices. The location servers 140a-140n may utilize the location related information received from the communication devices to create new profile elements, and/or to update, modify, and/or augment existing profile elements in the reference database 160. Accordingly, in various embodiments of the invention, communication devices, such as one or more of the mobile devices 102-106, may be operable to generate and/or propagate location related information. In this regard, the communication devices may support and/or run dedicated procedures and/or applications, and/or may be utilized dedicatedly to generate location related information corresponding to specific locations, and/or to devices and/or entities therein. The communication devices may also be operable to generate location related information while performing other tasks and/or applications.

In operation, the system 100 may provide network access to communication devices, such as the mobile device 102-106, via a plurality of wireless and/or wired networks. In this regard, the mobile device 102-106 may obtain network access wirelessly via the wireless AP 112, the cellular BS 114, and/or the WiMAX BS 116; and/or using wired connections, such as Ethernet based connections, to the Internet 130. The system 100 may also enable obtaining network access in a communication device via other communication devices. For example, the Smartphone 104 may utilize a wireless personal area network (WPAN) link to communicate with the laptop 106, using the network accessibility available via the laptop 106. Exemplary WPAN protocol may comprise, for example, Bluetooth and/or ZigBee.

The system 100 may support location based services (LBS). In this regard, the plurality of location servers 140a-140m may provide location based services (LBS) in the system 100. The location server 140a may generate, store, and/or update, in the reference database 150 for example, profile elements corresponding to communication devices in the system 100, such one or more of the wireless AP 112, the cellular BS 114, the WiMAX BS 116, and/or the mobile devices 102-106, and/or users thereof, for example. The location server 140a may access the SRN 160 to collect GNSS satellite data, and may utilize the collected GNSS satellite data to generate GNSS assistance data (A-GNSS data) pertaining to, and/or associated with the communication devices supported in the system 100. The location server 140a may also collect and/or retrieve location related data directly from the mobile devices 102-106, and/or from other communication devices in the system 100, such as, for example, the wireless AP 112, the cellular BS 114, and/or the WiMAX 116. The location related data may be stored in the reference database 150. The location server 140a may communicate the stored location related data when requested to do so. In addition, the reference database 150 maintained and/or utilized by the location server 140a may be modified, refined, and/or updated. The adjustments may be performed, for example, based on location related data received from the SRN 160. Location related data received from the mobile devices 102-106 and/or other communication devices in the system 100, and/or based on uses of and/or actions performed in the communication devices. The location related data maintained by the location server 140a may be utilized to augment and/or substitute for location related data received and/or generated based on communication with the GNSS network 120, for example, when communication with the GNSS network 120 is disturbed.

The location based services (LBS) applications may be utilized in the system 100 for authentication purposes. In this regard, the location related data stored and/or maintained in the location server 140a may be utilized to authenticate one or more of the mobile devices 102-106, users thereof, and/or locations thereof during operations performed by the mobile devices 102-106. For example, service providers may communicate with the location server 140a to request or invoke performance of authentication procedures by the location server 140a, and/or to obtain information necessary for directly performing the authentication procedures. The service providers may comprise, for example, cellular, WiMAX, and/or WLAN services providers. The authentication procedures may be performed based on existing information in the reference database 150, and/or based on current location information, which may be obtained by, for example, communicating with the communication devices, to verify their current location and/or connectivity status (or parameters thereof), for example. Location related data and/or information may be communicated, for example, via the Internet 130, utilizing Broadband IP packets over wired based connections for example.

Furthermore, various security protocols and/or procedures may be used by and/or be implemented within the system 100 to ensure secure exchange of location related data among, for example, the location servers 140a-140n, serviced entities and/or devices which may need be authenticated, such as wireless AP 112, the cellular 114, the WiMAX AP 116, the mobile devices 102-106, (and/or users thereof); and/or other entities and/or devices that may seek and/or require authentication of serviced devices and/or may provide necessary information during any such operations, such as services providers.

In an exemplary aspect of the invention, mobile devices, such as one or more of the mobile devices 102-106, may be utilized to generate and/or propagate location related information. In this regard, the location related data may correspond to certain locations, and/or to devices and/or entities therein. For example, the generated location related data may provide spatial details for a certain location, and/or may comprise data corresponding to any communication devices, including, for example, servicing communication devices located therein, which may be discovered at that location. The mobile devices 102-106 may utilize, for example, dedicated procedures and/or applications, and/or may be utilized dedicatedly for generating location related information at certain locations. The mobile devices 102-106 may also generate location related information while performing other tasks and/or applications. The generated location related information may be propagated to other mobile and/or communication devices. The receiving devices may utilize the generated location related data thereafter for providing and/or supporting location services and/or applications at those locations. For example, the receiving devices may utilize the received location related data to provide navigation services and/or to locate servicing devices that were previously unknown at the locations associated with the received location related data. The generated location related data location may ultimately be propagated, directly via the Internet 130 and/or to the servers 140a-140n, which may use the location related information received to update, adjust, and/or augment the reference database 160.

In various embodiments of the invention, the location related data may be generated based on, for example, tracking movement of a mobile device, such as the mobile device 104, at locations associated with generated location related data. In this regard, movement related information, which may be generated based on tracking of the movements of the mobile device 104 relative to an initial position and/or absolute location, may be utilized to generate a profile for a certain location (e.g. building) comprising, for example, location and/or positioning data and/or information, for that certain location, relative to that initial position and/or absolute location. In this regard, a position of the device may refer to the spatial positioning and/or orientation of the device, and may be defined in terms of a plurality of parameters, comprising, for example, bearing, horizontal, and/or vertical orientation of the device. The absolute location of a device may refer to the geographical location of that device, e.g. on Earth, which may be defined by a plurality of parameters, comprising, for example, longitude, latitude, and/or elevation (above/below sea-level). The initial absolute location may be determined directly based on, for example, reception of GNSS signals from one or more of the GNSS satellites 122a-122m in the GNSS network 120. The movement related information may be generated using, for example, sensors that monitor, track, and/or register linear and/or rotational changes in the position and/or location of a mobile device. Exemplary sensors may comprise, for example, magnetic bearing sensors, altimeters, accelerometers, pedometers, and/or gyroscopes. In this regard, the linear movement sensory data may be measured and/or recorded in a three-dimensional space, using x-y-z coordinates for example. Rotational movement sensory data may also be measured and/or recorded in a three-dimensional space, using roll, pitch and yaw parameters for example.

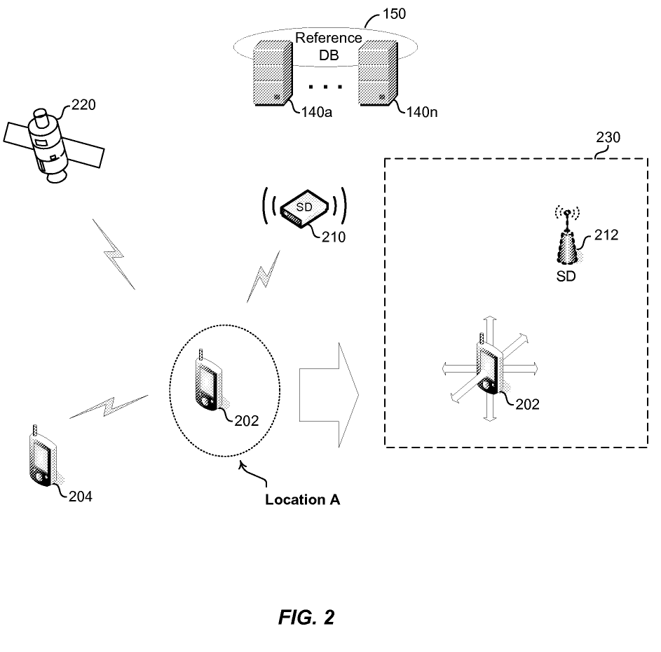

FIG. 2 is a block diagram illustrating an exemplary mobile device that is operable to generate and propagate location information using sensory data, in accordance with an embodiment of the invention. Referring to FIG. 2, there is shown a mobile device 202, a personal communication device 204, servicing communication devices 210 and 212, a GNSS satellite 220, and a location 230. Also shown in FIG. 2 are the location servers 140a-140n of FIG. 1.

The mobile device 202 may comprise suitable logic, circuitry, interfaces, and/or code for implementing various aspects of the invention disclosed herein. In this regard, the mobile devices 202 may communicate with other devices and/or systems, based on one or more wired and/or wireless protocols and/or standards. For example, the mobile device 202 may be operable to transmit and/or receive signals and/or messaging carried therein, over land-based Ethernet, WPAN, WLAN, cellular, WiMAX, GNSS, and/or FM connections and/or links. In an exemplary aspect of the invention, the mobile device 202 may be operable to generate and/or propagate location related information. In this regard, the mobile device 202 may generate location related data based on, for example, tracking and/or monitoring of movement of the mobile device 202 at a certain location. In some embodiments of the invention, the mobile device 202 may support LBS applications, and/or may be operable to communicate with the location servers, such the location servers 140a-140n for example.

The personal communication device 204 may be similar to the mobile devices 102-106, substantially as described with regard to, for example, FIG. 1. In an exemplary aspect of the invention, the personal communication device 204 may be operable to communicate with the mobile device 202, using one or more mutually supported wireless interface and/or protocol for example. The GNSS satellite 220 may be similar to one or more of the GNSS satellites 122a-122m, substantially as described with regard to, for example, FIG. 1. Accordingly, the GNSS satellite 220 may transmit satellite signals that may be utilized by land-based devices to enable GNSS based applications.

Each of the servicing communication devices 210 and 212 may comprise suitable logic, circuitry, interfaces, and/or code for providing network access services to one or more communicative devices, via wired and/or wireless connections. Exemplary servicing communication devices may comprise personal communication devices, wireless access points, WiMAX base stations, cellular base stations, and/or femtocells. In this regard, the servicing communication device 212 may comprise a WiFi access point at the location 230.

The location 230 may comprise a commercial or a residential property. Exemplary residential properties may comprise single-family homes or apartment buildings. Exemplary commercial properties may comprise stores, restaurants, office buildings, and/or hotels. In an exemplary embodiment of the invention described herein, location related data corresponding to the location 230, and/or devices therein, may not be available initially in the reference database 150 maintained by the location servers 140a-140n. In this regard, the existence of, and/or location related data associated with the servicing communication device 212 at 230 may not be available in the reference database 150.

In operation, the mobile device 202 may be utilized to generate location related data corresponding to the location 230, which may not be previously available to the location servers 140a-140n. In this regard, the mobile device 202 may generate the location related data associated with the location 230 based on, for example, movement of the 202 mobile device, and/or tracking and processing thereof, at the location 230. Determining absolute locations within the location 230, which may typically be used in generating location related data, may not possible. For example, in instances where the location 230 may comprise a high-rise apartment building, reception of GNSS signals may be not possible inside the building, especially away from the windows and/or in such areas as elevator shafts and/or the basement. Furthermore, wireless connectivity in such a building, and/or certain areas thereof, may also not be available. Therefore, location determination based on LBS applications and/or data may also not possible. According, in various embodiments of the invention the location related data corresponding to areas inside the location 230 may be generated relative to one or more known absolute locations, which may be determined outside and/or at the edge of the location 230. The mobile device may initially determine its absolute location, which may correspond to location A, and may then track and/or monitor its movements within the location 230 relative to the location A. In this regard, the mobile device 202 may determine its initial location (e.g. location A) directly, based on reception of GNSS signals from the GNSS satellite 220 for example, and/or based on A-GNSS data which may be retrieved from the location servers 140a-140n.

In some embodiments of the invention, the mobile device 202 may not be capable of determining its absolute location directly and/or autonomously. The mobile device 202 may not be able to use, for example, GNSS signaling because the mobile device 202 may not incorporate GNSS based functionality and/or because GNSS signals may be blocked due to, for example, terrain or other obstacles. The mobile device 202 may also not support LBS application and/or may not be capable of communicating with the location servers 140a-140n, to obtain A-GNSS data for example. Accordingly, the mobile device 202 may estimate its initial absolute location based on the absolute location of other communication devices which may be communicatively coupled to the mobile device 202. For example, the mobile device 202 may estimate its initial location based on the absolute location of the servicing communication device 210 and/or the personal communication device 204, with which the mobile device 202 may establish one or more wireless connections. In this regard, each of the servicing communication device 210 and/or the personal communication device 204 may determine its absolute location based on GNSS signals from the GNSS satellite 220 and/or A-GNSS data which may be retrieved from the location servers 140a-140n. That absolute location data corresponding to the servicing communication device 210 and/or the personal communication device 204 may then be communicated to the mobile device 202. The mobile device 202 may then estimate its location by determining, for example, the separation between it and each of the servicing communication device 210 and/or the personal communication device 204, based on transmit and/or receive power measurements for example.

In an exemplary embodiment of the invention, the mobile device 202 may be operable to enhance estimation of initial absolute location based on location data of communicatively coupled devices by, for example, selectively choose among the received location data to generate more accurate estimation of its absolute location. In this regard, the mobile device 202 may process the received location data to rate, for example, the quality of the received location data corresponding to each device communicatively coupled to the mobile device 202, and may accordingly determine its location based on the location data that are deemed to provide the most reliable and/or accurate positioning information. The mobile device 202 may also dynamically re-estimate its absolute location when better positioning info become available, from a new device that becomes communicatively coupled to the mobile device 202 for example.

Once the initial location of the mobile device 202 is determined and/or is estimated, the mobile device may start tracking its movement, inside the location 230 for example, and may generate corresponding movement data. For example, the mobile device 202 may utilize a plurality of sensors to track and/or monitor its movement relative to the determined initial location, location A, and to generate corresponding sensory data. The plurality of sensors may be internally integrated into the mobile device 202 or may be externally coupled to the mobile device 202. Exemplary sensors may comprise magnetic bearing sensors, gyroscopes, altimeters, accelerometers, and/or pedometers. The movement of mobile device 202 may be tracked and/or monitored as 3-dimensional (3D) linear and/or rotational changes in position and/or location of the mobile device 202. In this regard, the linear movement sensory data may be measured and/or recorded in a three-dimensional space, using x-y-z coordinates for example. Rotational movement sensory data may also be measured and/or recorded in a three-dimensional space, using roll, pitch and yaw parameters, for example. The movement data may then be utilized to generate profile corresponding to the location 230. In this regard, the movement data may be used to estimate, for example, location of hallways and/or rooms within the location 230; number and/or location of floors, using changes in altitude for example; and/or to estimate presence and/or location of elevators for example, based on monitoring of speed of ascend and descend between floors as compared to normal human speed for example. The mobile device may also detect and/or determine presence of other devices which may not be currently known. For example, the mobile device 202 may determine, during movement within the location 230, existence of the servicing communication device 212. The mobile device 202 may then determine and/or generate location and/or operation related information corresponding to the servicing communication device 212, and may incorporate that information into the location related data corresponding to the location 230.

The mobile device may forward the generated location related data associated with location 230 to other communication devices, such as the personal communication device 204. The location related data may subsequently be utilized by the receiving devices. For example, the personal communication device 204 may support use of navigational applications within the location 230 using location related data generated by, and received from the mobile device 202.

In various embodiments of the invention, the mobile device 202 may support LBS applications and/or may communicate with location servers 140a-140n. Accordingly, the mobile device 202 may communicate with location servers 140a-140n prior to any steps performed for generating location related data corresponding to the location 230. The location servers 140a-140n may determine, for example, whether the location related data corresponding to the location 230 currently exist in the reference database 150, and/or whether generating this data is necessary, and may accordingly authorize the mobile device 202 to generate the data. The mobile device 202 may propagate the generated location that is associated with the location 230 to the location servers 140a-140n, via Broadband IP connections for example.

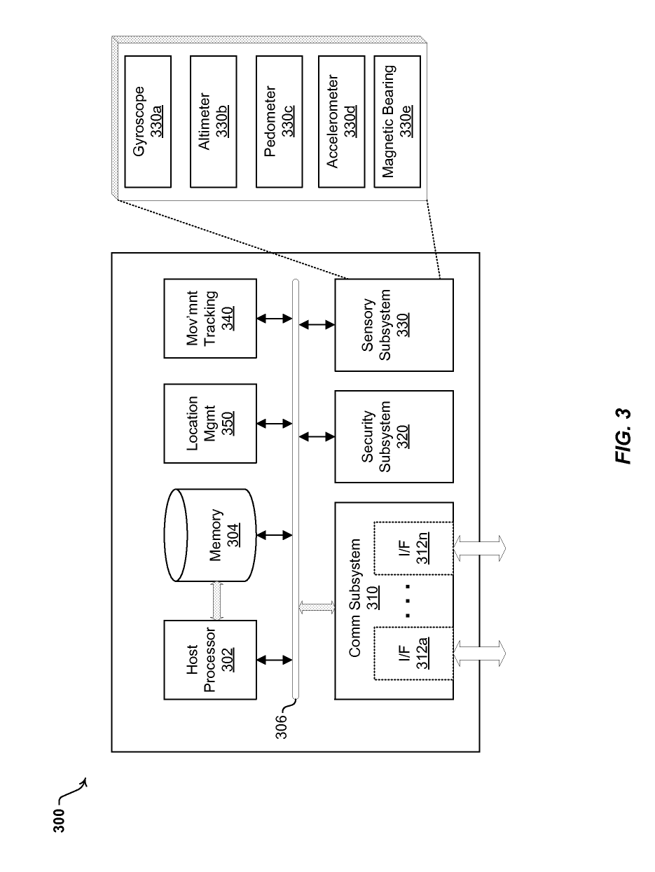

FIG. 3 is a block diagram illustrating an exemplary processing system that is operable to generate and propagate location information based on sensory data, in accordance with an embodiment of the invention. Referring to FIG. 3 there is shown a system 300, a host processor 302, a system memory 304, a system bus 306, a communication subsystem 310, a security subsystem 320, a sensory subsystem 330, a movement tracking processor 340, and a location management processor 350.

The system 300 may comprise the host processer 302, the system memory 304, the system bus 306, the communication subsystem 310, the security subsystem 320, the sensory subsystem 330, the movement tracking processor 340, and the location management processor 350. The system 300 may be integrated into a communication device, such as the mobile device 202 for example, to support and/or implement various aspects of the invention disclosed herein, substantially as described with regard to, for example, FIGS. 1 and 2.

The host processor 302 may comprise suitable logic, circuitry, interfaces, and/or code that may be operable to process data and/or control operations of the system 300. In this regard, the host processor 302 may configure and/or control operations of various components and/or systems of the system 300, by providing, for example, control signals. The host processor 302 may also control data transfers within the system 300. The host processor 302 may enable execution of applications, programs and/or code, which may be stored in the system memory 304 for example, to enable performing various web browsing support operations. The system memory 304 may comprise suitable logic, circuitry, interfaces, and/or code that enable permanent and/or non-permanent storage and/or fetching of data, code and/or other information used in the system 300. In this regard, the system memory 304 may comprise different memory technologies, including, for example, read-only memory (ROM), random access memory (RAM), and/or Flash memory. The system memory 304 may store, for example, information comprising configuration data. The configuration data may comprise parameters and/or code, which may comprise software and/or firmware, but the configuration data need not be limited in this regard.

The system bus 306 may comprise suitable logic, circuitry, interfaces, and/or code that may enable exchange of data and/or information between various components and/or systems in the system 300. In this regard, the system bus may comprise parallel or serial, and/or internal or external based bus technologies, and/or any combinations thereof. Exemplary system bus interfaces may comprise Inter-Integrated Circuit (I²C), Universal Serial Bus (USB), Advanced Technology Attachment (ATA), Small Computer System Interface (SCSI), Peripheral Component Interconnect (PCI), and/or Peripheral Component Interconnect Express (PCI-e) based interfaces.

The communication subsystem 310 may comprise suitable logic, circuitry, code, and/or interfaces that may enable communication of data, content, and/or messaging from and/or to the system 300, based on one or more wired and/or wireless protocols. The communication subsystem 310 may comprise, for example, a plurality of I/F processing blocks 312a-312n that may be operable to perform communication based on wired or wireless standards supported in the system 300. In this regard, each of the plurality of I/F processing blocks 312a-312n may comprise suitable logic, circuitry, interfaces, and/or code that are operable to detect, receive, and/or transmit signals based on specific frequency bands and/or modulation schemes. The I/F processing blocks 312a-312n may also be operable to perform necessary processing operations, which may comprise, for example, buffering, filtering, modulation/demodulation, up-conversion/down-conversion, and/or digital-to-analog/analog-to-digital conversion. The plurality of the IF processing blocks 312a-312n may be configured to support, for example, transmission and/or reception of RF signals during communication based on Ethernet, Bluetooth, WLAN, cellular, WiMAX, GNSS, FM interfaces and/or protocols.

The security subsystem 320 may comprise suitable logic, circuitry, interfaces, and/or code that may operable to perform security related operations in the system 300. In this regard, the security subsystem 320 may perform device and/or user authentication, certificate usage, and/or cryptographic operations in the system 300.

The sensory subsystem 330 may comprise suitable logic, circuitry, code, and/or interfaces that may be operable to detect and/or track movement, and/or changes thereof, corresponding to a device comprising system 300, and to generate corresponding data. In this regard, the sensory subsystem 330 may generate movement related data corresponding to linear and/or rotational changes in the position and/or location of the system 300, relative to an initial location and/or position. The sensory subsystem 330 may be internally or externally coupled to the system 300. The sensory subsystem 330 may comprise, for example, a gyroscope 330a, an altimeter 330b, a pedometer 330c, an accelerometer 330d, and/or a magnetic bearing sensor 330e.

The gyroscope 330a may comprise suitable logic, circuitry, code, and/or interfaces that may be operable to track and monitor angular orientation, and/or changes thereof. In this regard, the may generate data corresponding to roll, pitch and yaw parameters, and/or changes thereof relative to an initial orientation, for example. In this regard, the gyroscope 330a may generate sensory data corresponding to angular orientation and/or rotation movements of a device comprising the system 300, relative to an initial position and/or orientation of that device.

The altimeter 330b may comprise suitable logic, circuitry, code, and/or interfaces that may be operable to track and/or measure altitude parameters, and/or changes thereof, relative to an initial and/or predetermined level. In this regard, the altimeter 330b may generate sensory data corresponding to changes of altitude and of a device comprising the system 300 relative to an initial location and/or position of that device.

The pedometer 330c may comprise suitable logic, circuitry, code, and/or interfaces that may be operable to track and/or measure linear movement, in one or more dimension, and/or changes thereof, relative to an initial and/or predetermined starting point. In this regard, the pedometer 330c may generate sensory data corresponding to movement of a device comprising the system 300 relative to an initial location of that device.

The accelerometer 330d may comprise suitable logic, circuitry, code, and/or interfaces that may be operable to track and/or measure linear acceleration, and/or changes thereof. In this regard, the accelerometer 330d may generate sensory data corresponding to acceleration (or deceleration), in one or more dimension when measured in 3-d space, of a device comprising the system 300.

The magnetic bearing sensor 330e may comprise suitable logic, circuitry, code, and/or interfaces that may be operable to track and/or measure magnetic bearing, and/or changes thereof. In this regard, the accelerometer 330d may generate sensory data corresponding to changes in the magnetic bearing, based on magnetic field of the Earth for example, in one or more dimension when measured in 3-d space, of a device comprising the system 300.

The movement tracking processor 340 may comprise suitable logic, circuitry, interfaces, and/or code that may operable to manage and/or control movement tracing operations in the system 300, substantially as described with regard to, for example, FIGS. 1 and 2. In this regard, the movement tracking processor 340 may control and/or manage the sensory subsystem 330, and/or may process sensory data generated by the sensory subsystem 330 during tracking of movements of a device comprising the system 300. While the movement tracking processor 340 is shown as a separate component within the system 300, the invention need not be so limited. For example, the functionality and/or operations described herein with regard to the movement tracking processor 340 may be performed by other components of the system 300, such as the host processor 302 for example.

The location management processor 350 may comprise suitable logic, circuitry, interfaces, and/or code that may operable to perform, manage, and/or control location determination in the system 300, substantially as described with regard to, for example, FIGS. 1 and 2. In this regard, the location management processor 350 may be operable to determine location information corresponding to system 300 based on direct reception of GNSS signals, via the communication subsystem 310 for example, and/or retrieval of A-GNSS data, from the location servers 140a-140n for example. Alternatively, the location management processor 350 may estimate location of system 300 based on location of one or more communication devices, which may be communicate their location data to the system 300 via the communication subsystem 310.

In operation, the system 300 may be operable to support communication based on one or more wired or wireless interfaces. In this regard, the system 300 may enable receiving and/or transmitting, via the communication subsystem 310, signals carrying messaging and/or data, over wired-based Ethernet, WPAN, WLAN, cellular, WiMAX, femtocell, GNSS, and/or FM based connections. During operations in the system 300, the host processor 302 may manage and/or control operations of, for example, communication subsystem 310 and/or security subsystem 320. The system 300 may also support LBS applications and/or services. In this regard, the system 300 may communication with, using the communication subsystem 310 for example, a location server, such as the location server 140a of FIG. 1. The system 300 may, for example, interact with the location server 140a, via the internet 130, using the I/F processing block 312a, which may be configurable for wired, Ethernet based communications. During LBS related operations in the system 300, the security subsystem 320 may support various authentication and/or confidentiality related operations performed via the system 300. In this regard, the security subsystem 320 may assist and/or interact with the location server 140, for example, to enable performing communication device and/or user authentication procedures.

In an exemplary aspect of the invention, the system 300 may support tracking of movement of a device comprising the system 300 relative to an initial location and/or position of the device. For example, the system 300 may be integrated into the mobile device 202, to enable generation of location related data corresponding to one or more specific locations, such as location 230, substantially as described with regard to, for example, FIG. 2. In this regard, the sensory subsystem 330 and/or tracking movement processor 340 may be utilized to generate sensory data corresponding to linear and/or rotational changes in the position and/or location of the mobile device 202 relative to an initial location and/or position. In this regard, the location management processor 350 may determine and/or estimate the initial location and/or position corresponding to the system 300, substantially as described with regard to, for example, FIG. 2. The generated sensory data may be processed, by the tracking movement processor 340 and/or the host processor 302, to generate location related data corresponding to the location 230, substantially as described with regard to, for example, FIG. 2. The generated location related data may then be propagated, via the communication subsystem 310, to other communication devices and/or to location servers, such as the location servers 140a-140n.

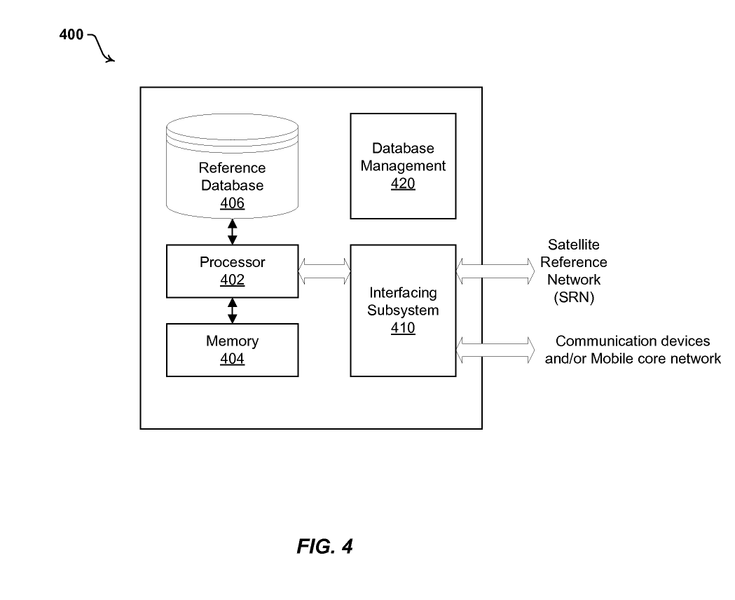

FIG. 4 is a block diagram illustrating an exemplary location server, in accordance with an embodiment of the invention. Referring to FIG. 4 there is shown a server 400, a host processor 402, a system memory 404, an interfacing subsystem 406, a reference database storage 410, and database management processor 420.

The server 400 may comprise the host processor 402, the system memory 404, the reference database storage 410, the interfacing subsystem 406, and the database management processor 420. The server 400 may correspond to, for example, one or more of the location servers 140a-140n of FIG. 1. In this regard, the server 400 may be operable to provide and/or support location based services (LBS). The server 400 may maintain, via the reference database storage 410 for example, data that may be used via mobile devices to identify and/or locate servicing communication devices at a certain location. In this regard, the reference database storage 410 may store at least some of the elements profiles of the reference database 150.

The host processor 402 may comprise suitable logic, circuitry, interfaces, and/or code that may be operable to manage and/or control operations of the server 400. In this regard, the host processor 402 may be operable to configure and/or control operations of various components and/or systems of the server 400, by providing, for example, control signals. The host processor 402 may also control data transfers within the system 400, including data storage and/or retrieval from system memory 404 and/or generating, storing, and/or updating elements in the reference database storage 410. The host processor 402 may enable execution of applications, programs and/or code, which may be stored in the system memory 404 for example, to enable performing various services and/or application requested from the server 400, including location based services (LBS) applications for example. The system memory 404 may comprise suitable logic, circuitry, interfaces, and/or code that enable permanent and/or non-permanent storage and/or fetch of data, code and/or other information used in the server 400. In this regard, the system memory 404 may comprise different memory technologies, including, for example, read-only memory (ROM), random access memory (RAM), and/or Flash memory. The system memory 404 may be operable to store, for example, data and/or code used during LBS operations in the server 400. The data and/or code may comprise configuration data or parameters, and the code may comprise operational code such as software and/or firmware, but the information need not be limited in this regard.

The interfacing subsystem 406 may comprise suitable logic, circuitry, interfaces, and/or code that may enable communication of data, content, and/or messaging from and/or to the server 400. The interfacing system 410 may support, for example, a plurality of physical and/or logical connections, based on one or more wired and/or wireless interfaces in the server 400. In this regard, the interfacing system 340 may comprise, for example, one or more network interface cards (NIC) and/or wireless network interface cards (WNIC).

The reference database storage 410 may comprise suitable logic, circuitry, interfaces, and/or code that may be operable to store location related data of associated communication devices. The reference database storage 410 may be internally or externally coupled to the server 400. The stored location related data may be provided to associated devices and/or users to support LBS applications. The reference database storage 410 may be operable to manage and update the stored location related data when requested, dynamically whenever any change is detected, and/or periodically. In an exemplary aspect of the invention, the reference database storage 410 may be updated and/or modified based on location related data, generated and/or communicated to the server 400 by communication devices.

The database management processor 420 may comprise suitable logic, circuitry, interfaces, and/or code that may operable to manage and/or control modifications of the reference database storage 410. In this regard, the database management processor 420 may manage and/or control creating new profile elements, and/or updating existing profile elements, in the reference database storage 410 based on location related data that is received from communication devices. While the database management processor 420 is shown as a separate component within the server 400, the invention need not be so limited. For example, the functionality and/or operations described herein with regard to the database management processor 420 may be performed by other components of the server 400, such as the host processor 402 for example.

In operation, the server 400 may be utilized to provide location based services (LBS). To facilitate LBS operations and/or servicing via the server 400, the host processor 402 may be operable to communicate, via the interfacing subsystem 406, with a satellite reference network (SRN), such as the SRN 160, to collect, for example, GNSS satellite data by tracking GNSS constellations. The host processor 402 may utilize the collected GNSS satellite data to build and/or update the reference database storage 410, which may be coupled internally or externally to the server 400. The host processor 402 may retrieve or collect location related data from associated users, such as the device 200. The server 400 may provide location related data by retrieving it from the reference database storage 410. In this regard, the server 400 may store the location related data in the reference database storage 410 as profile elements that may be indexed using identifiers that are specific to supported devices and/or users thereof.

In an exemplary aspect of the invention, the server 400 may support updating and/or modifying reference databases based on location related data, generated and/or communicated by communication devices. In this regard, the server 400 may receive, via the interfacing subsystem 406 for example, location related data, generated by the mobile device 202 for example, substantially as described with regard to FIG. 2. In this regard, the database management processor 420 may process the received location related data, and may, accordingly, create new profile elements and/or update or modify existing profile elements in the reference database storage 410.

In an exemplary embodiment of the invention, the server 400 may interact with communication devices prior to any generation of location related data thereby, and may authorize any such generation. For example, the server 400 and he mobile device 202 may interact, via the interfacing subsystem 410, prior to any steps performed by the mobile 202 for generating location related data corresponding to the location 230. Accordingly, the server 400 may determine whether the location related data corresponding to the location 230 currently exist in the reference database storage 410, and/or whether generating this data is necessary, and may accordingly authorize the mobile device 202 to generate the data.

In an exemplary embodiment of the invention, in instances where multiple mobile devices may be available for generating location related data corresponding to a specific location, the server 400 may arbitrate and/or coordinate, via the database management processor 420 for example, operations of the available mobile devices in this regard. For example, the server 400 may only authorize some mobile devices, based on suitability of sensory application and/or subsystems and/or workload for example, the task of generating the location related data. The server 400 may also require each mobile device to generate location related data corresponding to a portion of the desired location.

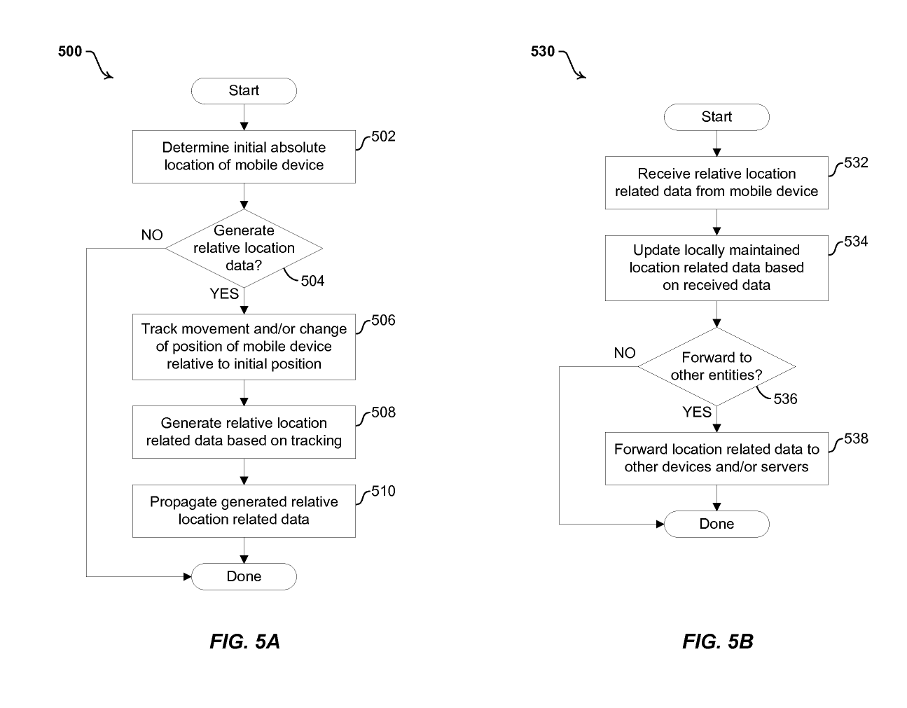

FIG. 5A is a flow chart that illustrates exemplary steps for generating and propagating location information based on sensory data, in accordance with an embodiment of the invention. Referring to FIG. 5A, there is shown a flow chart 500 comprising a plurality of exemplary steps that may be performed by a mobile device.

In step 502, an initial absolute location of a mobile device may be determined. For example, the mobile device 202 may determine its initial absolute location. In this regard, the absolute location may be determined based on, for example, GNSS signals and/or LBS based applications and/or data, using location servers, such as one or more of the location servers 140a-140n. The location may also be estimated based on communication with communication devices. For example, the mobile device 202 may estimate its location based on absolute location data of the mobile device 204 and/or the servicing communication device 210, which may be generated based on location determination performed by the mobile device 204 and/or the servicing communication device 210, and communicated thereafter to the mobile device 202.

In step 504, it may be determined whether to track and/or generate relative location related data. In this regard, the mobile device 202 may, for example, communicate and/or interact with the location servers 140a-140n to determine whether generation of relative location related data for location 230 may be necessary. The location servers 140a-140n may authorize and/or request generated relative location related data based on, information comprising reported initial absolute location of the mobile device 202, substantially as described with regard to, for example, FIGS. 2 and 4. In instances where no generation of relative location related data may be necessary, the plurality of exemplary steps may terminate.

Returning to step 504, in instances where generation of relative location related data may be requested and/or authorized, the plurality of exemplary steps may proceed to step 506. In step 506, the mobile device may track movement related data. For example, the mobile device 202 may track, using the sensory subsystem 330 for example, its position change, and/or linear and/or rotational movement data relative to its determined initial absolute location. In step 508, relative location related data may be generated based on tracking of mobile devices movement and/or position related data. For example, the mobile device 202 may generate location related data for location 230 based on its movements and/or changes in its position within location 230, and/or relative to its initial position data corresponding to location A. The generated location related data may comprise information corresponding to previously undiscovered communication devices, such as the Servicing communication device 212 for example. In step 510, the generated relative location related data may be propagated. In this regard, the generated location related data may be forwarded to other communication devices and/or to location servers 140a-140n, directly or indirectly.

FIG. 5B is a flow chart that illustrates exemplary steps for receiving and/or utilizing location related data generated and communicated from a mobile device, in accordance with an embodiment of the invention. Referring to FIG. 5B, there is shown a flow chart 530 comprising a plurality of exemplary steps that may be performed by a communication device.

In step 532, a communication device that is communicatively coupled to a mobile device may receive location related data generated by the mobile device. For example, the personal communication device 204 and/or the servicing communication device 210, which may be communicatively coupled to the mobile device 202, may receive the relative location related data corresponding to location 230 generated by the mobile device 202, substantially as described with regard to, for example, FIGS. 2 and 5A. In step 534, the receiving communication device may process and/or use the location related data received from the mobile device, for updating locally maintained location related data for example. For example, the personal communication device 204 may store the location related data generated by the mobile device 202, corresponding to the location 230. In this regard, in instances where the personal communication device 204 is subsequently located within the location 230, the personal communication device 204 may utilize the location related data received from the mobile device 202 to provide, for example, navigational services within the location 230, and/or to locate the servicing communication device 212.

In step 536, it may be determined whether to forward location related data, received from a mobile device, to other devices and/or entities. In this regard, the personal communication device 204 and/or the servicing communication device 210 may determine whether (or not) to forward the location related data, corresponding to the location 230, which was generated by and/or prorogated from the mobile 202 when it is communicatively coupled to the personal communication device 204 and/or the servicing communication device 210. Determining when and/or if to forward the received location related may be based on, for example, configuration parameters, and/or availability of resources that may be necessary to perform any such forwarding. Furthermore, each of the mobile device 202, the personal communication device 204, and/or the servicing communication device 210 may be operable to expressly request and/or deny performing any such forward. In instances where the received location related data, the plurality of exemplary steps may proceed to step 538. In step 538, the communication device may propagate location related data received from the mobile device to other entities and/or devices, directly and/or indirectly, using the connectivity of the communication device. For example, the personal communication device 204 and/or the servicing communication device 210 may forward the location related data generated by the mobile device 202 in the location 230 to the location servers 140a-140n, which may utilize that location related data to update and/or modify the reference database 150, substantially as described with regard to, for example, FIG. 2.

Various embodiments of the invention may comprise a method and system for generating and propagating location information by mobile device using sensory data. The system 300 may be operable to determine an initial absolute location of a mobile device, such as the mobile device 202. The system 300 may be operable to track, using the sensory subsystem 330 and/or the movement tracking processor 340, movements of the mobile device 202 relative to the initial absolute location. The system 300 may generate location related data for a location, such as Location 230, based on that tracking. The sensory subsystem 330 may be integrated within the system 300, or it may be externally coupled to system 300. During tracking of movement of the mobile device 202, the sensory subsystem 330 may generate, using the gyroscope 330a, the altimeter 330b, the pedometer 330c, and/or the accelerometer 330d for example, movement data comprising three-dimensional (3D) linear and/or rotational changes in position and/or location of the system 300 may be generated. The movement data generated during tracking of movement of the mobile device 202 may be utilized, by the movement tracking processor 340 and/or host processor 302 for example, to generate the location related data for the location 230. The system 300 may communicate with, using the communication subsystem 310 for example, other communication and/or mobile devices, and/or with one or more of the location servers 140a-140n, directly or indirectly. In this regard, communicating with the location servers 140a-140n may be utilized to determine whether the location servers 140a-140n require and/or authorize the tracking of movement of the mobile device, and/or generating of the location related data based thereon. The system 300 may forward the generated location related data the other mobile and/or communication devices, and/or to the location servers 140a-140n. In this regard, the location servers 140a-140n may update the reference database 150, which may be used for supporting location related services (LBS), based on the generated location related data received from mobile devices.

The initial absolute location for the mobile device 202 may be determined directly, based on GNSS signals received by the mobile device 202 and/or based on assisted GNSS (A-GNSS) data received from the location servers 140a-140n. In some instances, the initial absolute location for a mobile device, such as the mobile device 202, may be estimated, via the host processor 302 for example, based on a location of a second communication device, such as the personal communication device 204. The communication device 204 may be communicatively coupled to the mobile device 202. In this regard, the system 300 may support use of one or more wireless connections, which may be used, via the system 300, for obtaining data corresponding to the absolute location of the mobile device 204, for example. Exemplary communication devices which may be utilized for estimating the initial absolute location of the mobile device 202 may comprise personal communication devices, wireless access points, WiMAX base stations, cellular base stations, and/or femtocells.

Other embodiments of the invention may provide a non-transitory computer readable medium and/or storage medium, and/or a non-transitory machine readable medium and/or storage medium, having stored thereon, a machine code and/or a computer program having at least one code section executable by a machine and/or a computer, thereby causing the machine and/or computer to perform the steps as described herein for seamless consummation of an electronic transaction based on location related data.

Accordingly, the present invention may be realized in hardware, software, or a combination of hardware and software. The present invention may be realized in a centralized fashion in at least one computer system, or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A method for communication, the method comprising:
in a mobile device comprising one or more movement sensors, and/or a location device:
determining an initial absolute location of said mobile device, wherein said determining comprises estimating said initial absolute location of said mobile device based on location data of one or more communication devices that are communicatively coupled to said mobile device; and
when said mobile device is moving and subsequent absolute location of said mobile device cannot be determined:
tracking movement of said mobile device utilizing said one or more movement sensors; and
generating location related data relative to said initial absolute location of said mobile device based on said tracking of said movement of said mobile device.

2. The method according to claim 1, comprising determining said initial absolute location of said mobile device utilizing said location device.

3. The method according to claim 1, wherein said location device comprises a GNSS receiver.

4. The method according to claim 1, comprising determining said initial absolute location based on received GNSS signals and/or based on assisted GNSS (A-GNSS) data received from one or more location servers.

5. (canceled)

6. The method according to claim 1, comprising generating, based on said tracking by said one or more sensors, movement data comprising three-dimensional (3D) linear and/or rotational changes in position and/or location of said mobile device relative to said initial absolute location.

7. The method according to claim 1, wherein said one or more sensors comprises a gyroscope, an altimeter, an accelerometer, and/or a pedometer.

8. The method according to claim 1, comprising communicating said generated location related data to other devices and/or to one or more location servers that support location based services (LBS).

9. The method according to claim 8, wherein said one or more location servers are operable to update a reference database for supporting LBS applications based on said generated location related data.

10. The method according to claim 1, comprising communicating with one or more location servers that support location based services (LBS), wherein said one or more location servers are operable to request and/or authorize said generation of said location related data.

11. A system for communication, the method comprising:
one or more processors and/or circuits for use in a mobile device that comprises one or more movement sensors, and/or a location device, said one or more processors and/or circuits are operable to:
determine an initial absolute location of said mobile device, wherein said determining comprises estimating said initial absolute location of said mobile device based on location data of one or more communication devices that are communicatively coupled to said mobile device; and
when said mobile device is moving and subsequent absolute location of said mobile device cannot be determined:
track movement of said mobile device utilizing said one or more movement sensors; and
generate location related data relative to said initial absolute location of said mobile device based on said tracking of said movement of said mobile device.

12. The system according to claim 11, wherein said one or more processors and/or circuits are operable to determine said initial absolute location of said mobile device utilizing said location device.

13. The system according to claim 11, wherein said location device comprises a GNSS receiver.

14. The system according to claim 11, wherein said one or more processors and/or circuits are operable to determine said initial absolute location based on received GNSS signals and/or based on assisted GNSS (A-GNSS) data received from one or more location servers.

15. (canceled)

16. The system according to claim 11, wherein said one or more processors and/or circuits are operable to generate, based on said tracking by said one or more sensors, movement data comprising three-dimensional (3D) linear and/or rotational changes in position and/or location of said mobile device relative to said initial absolute location.

17. The system according to claim 11, wherein said one or more sensors comprises a gyroscope, an altimeter, an accelerometer, and/or a pedometer.

18. The system according to claim 11, wherein said one or more processors and/or circuits are operable to communicate said generated location related data to other devices and/or to one or more location servers that support location based services (LBS).

19. The system according to claim 18, wherein said one or more location servers are operable to update a reference database for supporting LBS applications based on said generated location related data.

20. The system according to claim 11, wherein said one or more processors and/or circuits are operable to communicate with one or more location servers that support location based services (LBS), wherein said one or more location servers are operable to request and/or authorize said generation of said location related data.
